(19) United States
(12) Patent Application Publication
(10) Pub. No.: US 2007/0008504 A1
(43) Pub. Date: Jan. 11, 2007

(54) Projector with light-shading device and method for blocking scattering light thereof

(76) Inventor: Sheng Wei Lin, Taoyuan (TW)

Correspondence Address: SUTHERLAND ASBILL & BRENNAN LLP, 999 PEACHTREE STREET, N.E., ATLANTA, GA, 30309, US

(21) Appl. No.: 11/472,906

(22) Filed: Jun. 22, 2006

(30) Foreign Application Priority Data
Jul. 11, 2005 (TW) 94123456

(51) Int. Cl. G03B 21/28

(52) U.S. Cl. 353/99

(57) ABSTRACT

A projector with a light-shading device is provided. The projector includes an illuminating system, a micromirror device and a projection lens, wherein the illuminating system includes a light source producing a light, a condenser lens condensing the light from the light source, and a reflection device reflecting the light from the condenser lens; the micromirror device receives the light reflected by the reflection device, processes the light and then reflects the light therefrom; the projection lens receives the light from the micromirror device and then focuses the light; and the light-shading device is disposed between the illuminating system and the micromirror device for blocking a scattering light produced by the illuminating system.

### FIELD OF THE INVENTION

The present invention is related to a projector. More particularly, the present invention is related to the projector with a digital micromirror device (DMD) for preventing the influence of a scattering light thereof.

### BACKGROUND OF THE INVENTION

The working principle for the projector with a digital micromirror device (DMD) is that the DMD has plural micromirrors therein as the light switches. The DMD receives the digital messages, such as the bits of a digital electrical message, and produces light bit outputting by changing the incline angles of those micromirrors. Each of the micromirrors reflects the light at two angles and works well by cooperating with a light source and a projection lens. When the micromirror is in the “on” status, it swings to an angle for reflecting the light from the light source to the projection lens so as to present an image on a screen. When the micromirror is in the “off” status, it swings to another angle for reflecting the light from the light source to anywhere except the projection lens, such that the image on the screen corresponding to the micromirror in the “off” status is black. The DMD receives electrical bits and outputs light bits. Such technique is called the “binary pulse width modulation”, but the detail of this technique is not the point of the present invention and will not be further discussed hereafter.

Please refer to FIG. 2, which is a schematic diagram showing the inner structure of a projector using the digital micromirror device according to the prior art. The light emitted from the light source 10 is condensed by the condenser lens 12 for providing the light to the digital micromirror device 2 as evenly as possible. The digital micromirror device 2 processes the received light and reflects it to the projection lens 5. Then, through the projection lens 5, the light is focused on a screen (not shown) for forming an effective imaging area 41′. In consideration of providing the light fully covering the digital micromirror device 2, and the round shape of the illuminated area provided by the condenser lens 12, the digital micromirror device 2 could be considered as a cyclic quadrilateral for the illuminated area provided by the condenser lens 12. Therefore, portions of the illuminated area must exceed the scope of the digital micromirror device 2, i.e. the scattering light area 45 around the digital micromirror device 2. On the contrary, the portion of the illuminated area provided by the condenser lens 12 that exactly covers the digital micromirror device 2 is defined as the effective light area 41.

Similarly, the image circle is used in the projection lens 5 for receiving all the light from the digital micromirror device 2. Therefore, in accordance with the light received and focused in the effective light area 41, the projection lens 5 receives the scattering light in the scattering light area 45 and then focuses it on the screen for forming a scattering imaging area 45′. Hence, the image outside the effective imaging area 41′ bothers the viewer.

Presently, there are several ways to solve the mentioned problem resulting from the scattering light. Performing the matting process for the components around the digital micromirror device 2 is one way. The decrease of the light reflected from the components around the digital micromirror device 2 could be achieved by increasing the surface roughness thereof. However, the mentioned light extinction (eliminating) technique in the prior art could just reduce the reflecting light around the digital micromirror device 2 and make the imaging area surrounding the digital micromirror device 2 look darker; that is to say, the scattering light cannot be completely extinguished thereby.

The other way to solve the scattering light problem is done by setting up the partitions around the digital micromirror device 2 for partitioning off the light. Although the light reflected from the electrical component around the digital micromirror device 2 are avoided, the reflected light around the digital micromirror device 2 are not entirely eliminated since the scattering light is still projected to the area around the digital micromirror device 2.

There is still another way, which directly shapes the light emitted from the illuminating system 100 into a square form. Since the light emitted from the illuminating system 100 usually passes through at least one reflecting mirror before reaching the digital micromirror device 2, the shapes of the illuminated area thereof are usually not as expected after the reflection.

Please refer to FIG. 1, which is a schematic diagram of a projector without a light-shading device in the prior art. As shown in FIG. 1, the projector 1 includes an illuminating system 100 for serving as a light source for the projector 1, wherein the illuminating system 100 includes a light source 10 for providing the first light 10′. The condenser lens 12 is configured in front of the light source 10, and usually is a lens assembly. The first light 10′ is directed to the condenser lens 12, and the condenser lens 12 condenses the first light 10′ to the second light 12′, which is further directed to a reflection mirror set 14. Usually the reflection mirror set 14 is composed of at least one reflection mirror. For example, the reflection mirror set 14 includes a first reflection mirror 141 and a second reflection mirror 142, wherein the first reflection mirror 141 receives the second light 12′ and reflects it to the third light 141′, which is directed to the second reflection mirror 142; the second reflection mirror 142 further reflects it to the fourth light 142′, which is directed to the digital micromirror device 2. The micro digital device 2 changes the inclinations of the micro reflection mirrors to form the image beam of light 20′ by reflecting out the fourth light 142′. The projection lens 5 captures the image beam of light 20′ and focuses it as the projecting beam of light 50′, and thus the projecting light area 4′ is formed therefrom.

In such case, the angle of the light incident on the digital micromirror device 2 cannot be too large, which is the reason for using the reflection mirror set 14. Therefore, by using the reflection mirror set 14, the light from the lateral side of the digital micromirror device 2 could be adjusted for providing light to the digital micromirror device 2 at a proper incidence angle, which will be further explained in the following. Since the illuminating system 100 occupies a certain space, the included angle between the illuminating system 100 and the digital micromirror device 2 is large. If the illuminating system 100 and the digital micromirror device 2 are enforced to set with a small included angle therebetween, the configuration of the projection lens 5 will be affected.

That is to say, the projection lens 5 will be configured closely adjacent to the illuminating system 100. In addition, since the projection lens 5 must be set nearly in front of the digital micromirror device 2, they will affect each other. For example, in the case of providing sufficient illuminating intensity, the occupied spaces of the condenser lens 12 and the illuminating system 100 are increased, and hence the space for the projection lens 5 is restricted. Accordingly, the zoom lens or the tilt and shift lens with a longer length and diameter usually occupying a larger space than that of the general lens could not be used. Similarly, if the zoom lens or the tilt and shift lens is used, the room for the illuminating system 100 will not be large enough and it must be shifted to a lateral space, which is away from the projection lens 5, for avoiding the influence therefor.

However, shifting the illuminating system 100 away from the projection lens 5 as mentioned above will cause another problem, i.e. the large included angle between the illuminating system 100 and the digital micromirror device 2. Hence, for solving the above-mentioned problem, the reflection mirror set 14 is used for changing the direction of the light emitted from the illuminating system 100, and thus the light reaches the digital micromirror device 2 with an incident angle as small as possible. Therefore, with the help of the first reflection mirror 141 and the second reflection mirror 142 of the reflection mirror set 14, the fourth light 142′ reaches the digital micromirror device 2 with an incident angle as small as possible.

With the help of the first reflection mirror 141 and the second reflection mirror 142, each micromirror of the digital micromirror device 2 could receive the light with nearly identical intensity, but the light area illuminated by the light reflected from the first reflection mirror 141 is different from that illuminated by the second light 12′. This is because that both of the first reflection mirror 141 and the second reflection mirror 142 defectively reflect the light. Accordingly, the projecting area 4 illuminated by the light passes two deflective reflections, the first reflection mirror 141 and the second reflection mirror 142, which are quiet different from the light area illuminated by the second light 12′.

Please take a further look at FIG. 1, the projecting area 4 illuminated by the fourth light 142′ is approximately a trapezoid, which includes the effective light area 41 and the distortion area 43, wherein the effective light area 41 represents the light area covering the digital micromirror device 2, and the distortion area 43 represents the light area illuminating the surrounding portions of the digital micromirror device. Since the projection lens 5 used are usually a zoom lens or the tilt and shift lens, the image zone thereof are bigger than the lens without these functions. In such case, if the distortion area 43 exists inside the image zone of the projection lens 5, it will be captured by the projection lens 5 and projected out for forming the projecting light area 4′. Meanwhile, the effective imaging area 41′ and the distortion imaging area 43′ are respectively corresponding to the effective light area 41 and the distortion light area 43.

In comparison with FIG. 2, the distortion light area 43 shown in FIG. 1 is much lesser than the scattering light area 45 shown in FIG. 2, and sometimes the distortion imaging area 43′ will not be projected on a screen (however, it will form an image on the surrounding the screen), but the distortion imaging area 43′ still brothers the viewer.

For overcoming the foregoing disadvantages of the conventional projector, a projector with a light-shading device for effectively and easily avoiding the interference of the scattering light and the method therefor are provided in the present invention.

### SUMMARY OF THE INVENTION

In accordance with an aspect of the present invention, a projector with a light-shading device is provided. The projector includes an illuminating system, a micromirror device and a projection lens, wherein the illuminating system includes a light source producing a light, a condenser lens condensing the light from the light source, and a reflection device reflecting the light from the condenser lens; the micromirror device receives the light reflected by the reflection device, processes the light and then reflects the light therefrom; the projection lens receives the light from the micromirror device and then focuses the light; and the light-shading device is disposed between the illuminating system and the micromirror device for blocking a scattering light produced by the illuminating system.

Preferably, the projector further includes a projecting area produced by the reflection device. The projecting area includes an effective area covering the micromirror device and defined by an effective light path formed between the effective area and the reflection device; and a distortion area surrounding the effective area, and defined by a distortion light path formed between the distortion area and the reflection device, wherein the distortion light is formed from a reflection of the scattering light, and the light-shading device blocks the distortion light.

Preferably, the reflection device further includes a first mirror changing a direction of the light from the light source; and a second mirror receiving the light from the first mirror and then reflecting the light to the micromirror device.

Preferably, the light-shading device is a mask.

Preferably, the light-shading device is processed by a matting process.

Preferably, the matting process is one of a mat painting treatment and a tufting treatment.

In accordance with another aspect of the present invention, a method for eliminating a scattering light in a projector is provided. The method includes the steps of (a) providing an illuminating system as a light source for the projector; (b) providing a micromirror device for processing an effective light from the illuminating system and then reflecting the effective light beam out therefrom; (c) providing a light-shading device between the illuminating system and the micromirror device; (d) providing a projection lens for receiving the effective light from the micromirror device and then focusing the effective light on a screen, wherein the light-shading device blocks the scattering light from the illuminating system for preventing the scattering light from being projected to a surrounding of the micromirror device.

Preferably, the scattering light surrounds the effective light.

In accordance with a further aspect of the present invention, another projector is provided. The projector includes an illuminating system, a micromirror device illuminated by the illuminating system, a lens receiving a light from the micromirror device and focusing the light, and a light-shading device blocking a scattering light produced by the illuminating system.

Preferably, the scattering light from the illuminating system is reflected as a distortion light, the distortion light illuminates the surrounding of the micromirror device, and the light-shading device blocks the distortion light.

Preferably, the light-shading device is a plate directly blocking the scattering light away.

Preferably, the light-shading device is treated by one of a mat painting and a tufting processes.

Preferably, the micromirror device is a digital micromirror device.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 illustrates a schematic diagram of a projector without the light-shading device in the prior art;

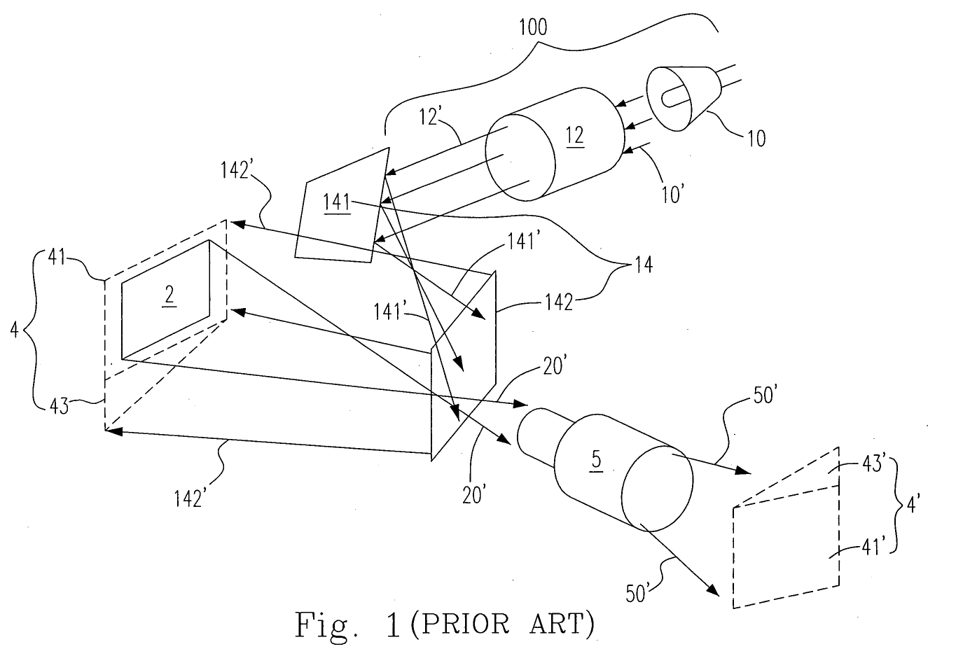

FIG. 2 is a schematic diagram showing the inner structure of a projector using the digital micromirror device according to the prior art;

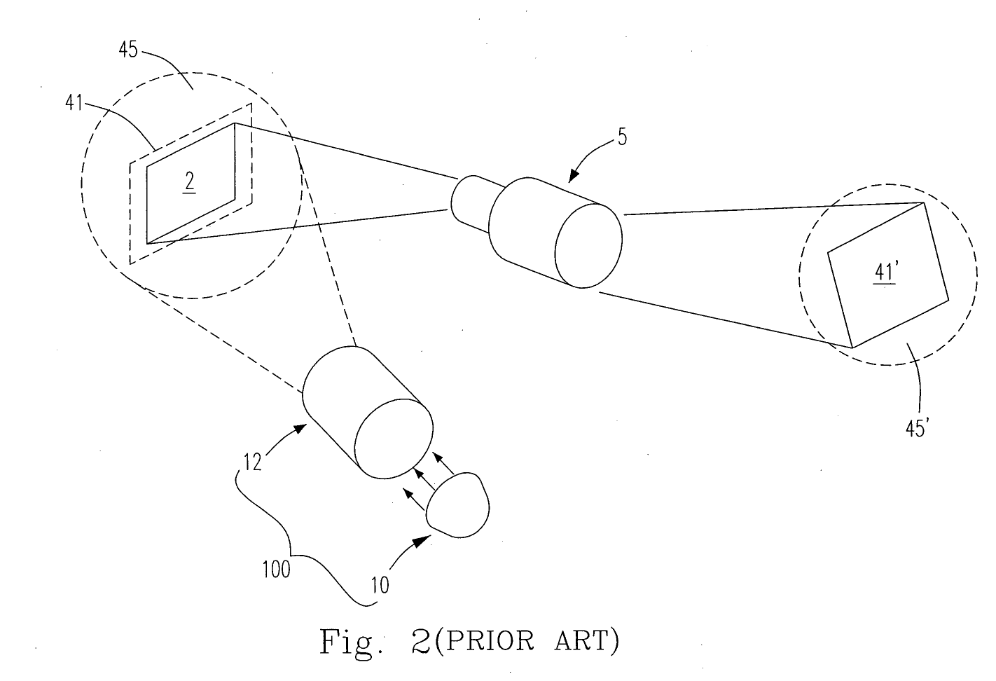

FIG. 3 is a diagram schematically showing the projector with a light-shading device according to a first embodiment of the present invention; and

FIG. 4 is a diagram schematically showing the light path formed between the second reflection mirror and the digital micromirror device according to the first embodiment of the present invention.

### DETAILED DESCRIPTION OF THE PREFERRED EMBODIMENT

The present invention will now be described more specifically with reference to the following embodiments. It is to be noted that the following descriptions of preferred embodiments of the invention are presented herein for purposes of illustration and description only; it is not intended to be exhaustive or to be limited to the precise form disclosed.

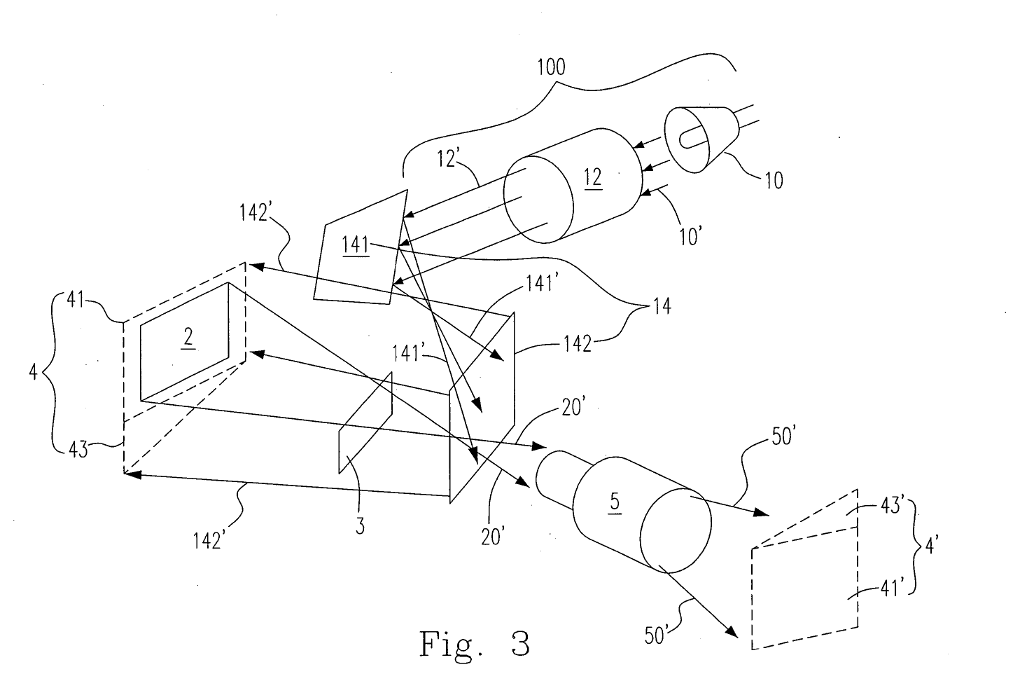

Please refer to FIG. 3, which is a diagram schematically showing the projector with a light-shading device according to a first embodiment of the present invention. The projector 1′ includes an illuminating system 100 for serving as a light source for the projector, wherein the illuminating system 100 includes a light source 10 for providing the first light 10′. The condenser lens 12 is configured in front of the light source 10, and usually is a lens assembly. The first light 10′ is directed to the condenser lens 12, and the condenser lens 12 condenses the first light 10′ to the second light 12′, which is further directed to a reflection mirror set 14. Usually the reflection mirror set 14 is composed of at least one reflection mirror. For example, the reflection mirror set 14 includes a first reflection mirror 141 and a second reflection mirror 142, wherein the first reflection mirror 141 receives the second light 12′ and reflects it to the third light 141′, which is directed to the second reflection mirror 142; the second reflection mirror further reflects it to the fourth light 142′, which is directed to the digital micromirror device 2. The digital micromirror device 2 changes the inclinations of the micro reflection mirrors to form the image beam of light 20′ by reflecting out the fourth light 142′. The projection lens 5 captures the image beam of light 20′ and focuses it as the projecting beam of light 50′, and thus the effective imaging area 41′ is formed therefrom. Certainly, the non-digital micromirror device is also applicable instead of the digital micromirror device. However, because the digital control is a more convenient way, only the digital micromirror device is illustrated in the present invention.

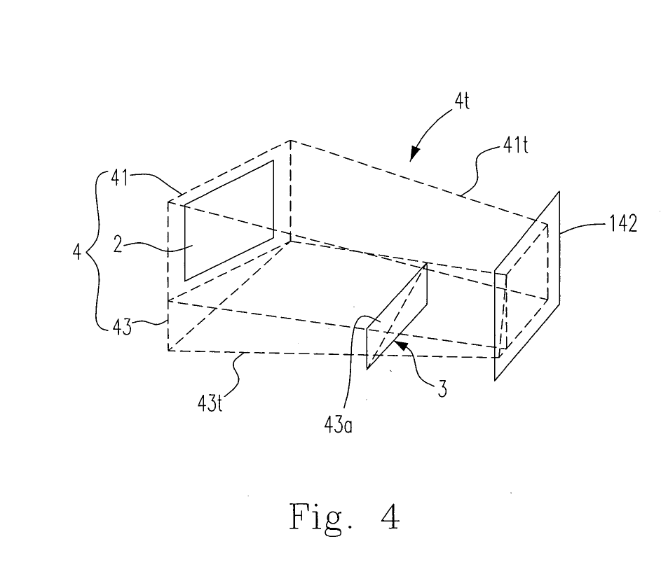

Please further refer to FIG. 4, which is a diagram schematically showing the light path formed between the second reflection mirror and the digital micromirror device according to the first embodiment of the present invention. The fourth light (not shown) reflected from the second reflection mirror 142 forms the projecting area 4, which includes the effective light area 41 and the distortion area 43, wherein the effective light area 41 covers the digital micromirror device 2, and the distortion area 43 is an area surrounding the effective light area 41 which is illuminated by the reflected scattering light. The projecting light beam 4t comprising the effective light 41t and the distortion light 43t is formed between the projecting area 4 and the second reflection mirror 142, wherein the effective light 41t is formed between the effective light area 41 and the second reflection mirror 142, and the distortion light 43t is formed between the distortion light area 43 and the second reflection mirror 142. Hence, the distortion light 43t is blocked and the scattering light will not illuminate the surrounding of the digital micromirror device 2. That is to say, only the effective light area 41 is projected on the digital micromirror device 2. Therefore, even if the image circle of the projection lens 5 (shown in FIG. 3) is able to cover the portions other than the effective light area 41, the image would not be affected by the scattering light. This is because the distortion light 43t is previously blocked by the light-shading device 3, the distortion light 43t blocked by the light-shading device 3 forms a blocked distortion light shadow 43a, and the surrounding of the digital micromirror device 2 is completely dark. Accordingly, the scattering light wound not form an image on the screen, and will not affect the viewer. Hence, only an effective imaging area 41′ is formed on the screen, and the distortion image area 43′ in the prior art is eliminated.

Please refer to both FIG. 3 and FIG. 4, it should noted that if the projection lens 5 is able to cover a huge area, such as a powerful tilt and shift lens having a bigger image circle, the configuration of the light-shading device 3 in the awl-shape path of the image beam of light 20′ shall be avoided; otherwise, the light-shading device 3 will be captured by the projection lens 5, and an image is formed on the screen. Based on the above descriptions, the present invention is implemented by setting the light-shade device 3 in a proper position of the confirmed path of the distortion light for blocking the distortion light in a position with a distance in front of the digital micromirror device 2. Hence, the present invention is adventurous since the scattering light is eliminated before reaching the surrounding of the digital micromirror device 2, which is quiet different from the passive mating process used in the prior art.

Although the light-shade device 3 is processed by the matting process, it should be noted that few light is still reflected from the light-shade device 3. Usually the mentioned matting process is a mat painting treatment or a tufting treatment. Therefore, the configuration of the light-shade device 3 should not in the direction face to the projection lens 5; otherwise, the image of the projector may be unclear. That is to say, preferably, the light-shade device 3 is configured in a way that it reflects the light, if there is any, to a place under the second reflection mirror 142.

In comparison with the projector in the prior art, the present invention is implemented by using the light-shade device for blocking the distortion light before it reaches the digital micromirror device 2 and the surrounding thereof. Hence, the present invention is adventurous for completely restricting the light from the illuminating system to be only projected on the digital micromirror device per se. Hence, the present invention is more efficient in eliminating the scattering light and the distortion light than the prior art.

While the invention has been disclosed in terms of what is presently considered to be the most practical and preferred embodiments, it is to be understood that the invention needs not to be limited to the disclosed embodiments. On the contrary, it is intended to cover various modifications and similar arrangements included within the spirit and scope of the appended claims which are to be accorded with the broadest interpretation so as to be accorded with the broadest interpretation so as to encompass all such modifications and similar structures.

What is claimed is:

1. A projector with a light-shading device, comprising:
an illuminating system comprising:
a light source producing a light;
a condenser lens condensing the light from the light source; and
a reflection device reflecting the light from the condenser lens;
a micromirror device receiving the light reflected by the reflection device, processing the light and then reflecting the light therefrom; and
a projection lens receiving the light from the micromirror device and then focusing the light, wherein the light-shading device is disposed between the illuminating system and the micromirror device for blocking a scattering light produced by the illuminating system.

2. The projector according to claim 1, further comprising a projecting area produced by the reflection device, wherein the projecting area comprises:
an effective area covering the micromirror device and defined by an effective light path formed between the effective area and the reflection device; and
a distortion area surrounding the effective area, and defined by a distortion light path formed between the distortion area and the reflection device, wherein the distortion light is formed from a reflection of the scattering light, and the light-shading device blocks the distortion light.

3. The projector according to claim 1, wherein the reflection device further comprises:
a first mirror changing a direction of the light from the light source; and
a second mirror receiving the light from the first mirror and then reflecting the light to the micromirror device.

4. The projector according to claim 1, wherein the light-shading device is a mask.

5. The projector according to claim 1, wherein the light-shading device is processed by a matting process.

6. The projector according to claim 5, wherein the matting process is one of a mat painting treatment and a tufting treatment.

7. A method for eliminating a scattering light in a projector, comprising steps of:
(a) providing an illuminating system as a light source for the projector;
(b) providing a micromirror device for processing an effective light from the illuminating system and then reflecting the effective light beam out therefrom;
(c) providing a light-shading device between the illuminating system and the micromirror device;
(d) providing a projection lens for receiving the effective light from the micromirror device and then focusing the effective light on a screen, wherein the light-shading device blocks the scattering light from the illuminating system for preventing the scattering light from being projected to a surrounding of the micromirror device.

8. The method according to claim 7, wherein the scattering light surrounds the effective light.

9. A projector comprising an illuminating system, a micromirror device illuminated by the illuminating system, a lens receiving a light from the micromirror device and focusing the light, and a light-shading device blocking a scattering light produced by the illuminating system.

10. The projector according to claim 9, wherein the scattering light from the illuminating system is reflected as a distortion light, the distortion light illuminates the surrounding of the micromirror device, and the light-shading device blocks the distortion light.

11. The projector according to claim 9, wherein the light-shading device is a plate directly blocking the scattering light away.

12. The projector according to claim 9, wherein the light-shading device is treated by one of a mat painting and a tufting processes.

13. The projector according to claim 9, wherein the micromirror device is a digital micromirror device.
